(19) United States
(12) Patent Application Publication
(10) Pub. No.: US 2026/0320854 A1
(43) Pub. Date: Oct. 15, 2026

(54) OCT Retinal Image Flattening

(71) Applicant: Carl Zeiss Meditec, Inc., Dublin, CA (US)

(72) Inventor: Everett J. Matthew, Livermore, CA (US)

(73) Assignee: Carl Zeiss Meditec, Inc., Dublin, CA (US)

(21) Appl. No.: 19/415,510

(22) Filed: Dec. 10, 2025

Related U.S. Application Data
(60) Provisional application No. 63/789,327, filed on Apr. 15, 2025.

(51) Int. Cl. G06T 11/00

(52) U.S. Cl. CPC G06T 11/00; G06T 2200/24; G06T 2210/22; G06T 2210/41

(57) ABSTRACT

System/Method/Device for storing and displaying an optical coherence tomography (OCT) scan of the retina of an eye. When acquiring a new OCT retina scan, the retina information is flattened and its curvature information, prior to flattening, is determined. A graphic representation of the curvature information is displayed alongside, or superimposed on, a display of a portion flattened retina. After a user modifies the portion of the flattened retina that is displayed, the displayed portion of the retina and the curvature information is stored into a computer-readable memory store, excluding any portion of the flattened retina not in the modified display.

### CROSS-REFERENCE TO RELATED APPLICATIONS

This application claims priority to, and the benefit of, Provisional Patent Application No. 63/789,327, filed Apr. 15, 2025, and titled “OCT RETINAL IMAGE FLATTENING,” which is incorporated by reference herein in its entirety for all purposes.

### FIELD

The present disclosure is generally directed to optical coherence tomography (OCT). More specifically, it is directed to displaying and storing OCT data.

### BACKGROUND

Background description of the problem, prior attempts for correction, and how these prior approaches are lacking.

Optical coherence tomography (OCT) is a non-invasive imaging technique that uses light waves to penetrate tissue and produce image information at different depths within the tissue, such as an eye. Generally, an OCT system is an interferometric imaging system based on detecting the interference of a reference beam and backscattered light from a sample illuminated by an OCT beam. Each scattering profile in the depth direction (e.g., z-axis or axial direction) may be reconstructed individually into an axial scan, or A-scan. Cross-sectional slice images (e.g., two-dimensional (2D) bifurcating scans, or B-scans) and volume images (e.g., 3D cube scans, or C-scans or volume scans) may be built up from multiple A-scans acquired as the OCT beam is scanned/moved through a set of transverse (e.g., x-axis and/or y-axis) locations on the sample. When applied to the retina of an eye, OCT generally provides structural data that, for example, permits one to view, at least in part, distinctive tissue layers and vascular structures of the retina. OCT angiography (OCTA) expands the functionality of an OCT system to also identify (e.g., render in image format) the presence, or lack, of blood flow in retinal tissue. For example, OCTA may identify blood flow by identifying differences over time (e.g., contrast differences) in multiple OCT scans of the same retinal region, and designating differences in the scans that meet predefined criteria as blood flow.

An OCT system also permits construction of a planar (2D), frontal view (e.g., en face) image of a select portion of a tissue volume (e.g., a target tissue slab (sub-volume) or target tissue layer(s), such as the retina of an eye). Examples of other 2D representations (e.g., 2D maps) of ophthalmic data provided by an OCT system may include layer thickness maps and retinal curvature maps. For example, to generate layer thickness maps, an OCT system may combine en face images, 2D vasculature maps of the retina, with multilayer segmentation data. Thickness maps may be based, at least in part, on measured thickness difference between retinal layer boundaries. Vasculature maps and OCT en face images may be generated, for example, by projecting onto a 2D surface a sub-volume (e.g., tissue slab) defined between two selected layer-boundaries. The projection may use the sub-volume's mean, sum, percentile, or other data aggregation method between the selected two layer-boundaries. Thus, the creation of these 2D representations of a 3D volume (or sub-volume) data often relies on the effectiveness of automated (multi) retinal layer segmentation algorithm(s) to identify the retinal layers (or layer-boundaries) upon which the 2D representations are based/defined.

As the resolution and imaging depth of OCT systems increases, the amount of data collected during an imaging scan also increases. This places a burden on both the data processing components, which operate at faster speeds and process larger amounts of data to keep up with the scan, and on memory to store the larger amounts of data.

The system reduces the overall amounts of data for processing and stored during an imaging scan, without reducing the point resolution and depth resolution of the imaging scan.

### SUMMARY

The above features are implemented in a method/system for processing, displaying, and storing an OCT scan of the retina of an eye.

An exemplary implementation includes acquiring a new OCT scan of the retina of an eye (e.g., a retina scan), such as by use of an OCT system. It is to be understood that a normal retina is generally curved, and so the retinal scan also shows a curved retina. The retina scan is then substantially flattened, by which the retina information within the OCT scan conveys a flattened representation of the original retina scan. At least a first portion of the flattened retina is then displaying on an electronic display. The flattening of the retina information may result in voids where there is no OCT data available. The displayed first portion optionally omits any such voids. A user may then modify the displayed portion of the flattened retina scan by use of an input device to define a second portion of the flattened retina information. For example, the user may enlarge, or reduce, or elongate, or shrink the displayed portion, or choose a different part of the flattened retina for display by sliding a viewing window along the length (span) of the retina. Any part of the flattened retina scan not within the displayed second portion is then removed (cropped) from the full, flattened retina scan to define a cropped OCT data scan, and cropped OCT data scan is stored to a computer-readable memory store. Any part of the full, flattened retina scan not within the cropped OCT data scan may be discarded, and not stored.

Optionally, first portion of the flattened retina information includes at least a select portion of the flattened retina information and a buffer region of OCT data above and below the select portion of the flattened retina within the OCT data. The buffer region may be modified by means of the user input device. For example, the depth the buffer region above and below the retina may be separately modified.

Additionally, a graphic conveying the curvature of the scanned retina prior to the flattening may be displayed on the electronic display alongside, or superimposed on the displayed portion of the flattened retina scan (optionally, both before and after modifying the displayed portion).

This curvature information may be determined directly from the not-flattened retina scan, or determined from the already flattened retina scan. For example, the flattening the retina information within the original OCT scan defines one or more regions of no-OCT data below the flattened retina, and the curvature of the retina prior to the flattening may be defined as the inverse of the curvature of the lower side of the defined region of no-OCT data below the flattened retina information.

The graphic may convey the curvature of a span of the retina larger than the span of cropped OCT data scan. For example, the graphic may convey the curvature of the original full retina scan prior to flattening and cropping.

Accessing the stored, cropped, flattened retinal scan later display may include the following steps. First, the stored (cropped and flattened) OCT scan data (e.g. flattened-and-cropped retina scan) is accessed from a memory stored flattened-and-cropped retina scan also includes the curvature information of the original retina scan prior to flattening and cropping. The accessed flattened-and-cropped retina scan is played on an electronic display along with a graphic conveying the curvature information of the retina. Optionally, the graphic may convey the curvature of only the displayed flattened-and-cropped retina scan, or convey the full curvature of the full retinal scan prior to flattening and cropping.

### BRIEF DESCRIPTION OF THE DRAWINGS

In the drawings wherein like reference symbols/characters refer to like parts:

FIG. 1 illustrate the cropping and flattening of a B-scan of a retina, in accordance with various embodiments.

FIG. 2 shows an original B-scan in an upper view, and a default, flattened scan B-scan view that an operator would see in a lower view, in accordance with various embodiments.

FIG. 3 shows a zoomed-out view of the B-scan of FIG. 2, in accordance with various embodiments.

FIG. 4 shows another example of the system, in accordance with various embodiments.

FIG. 5 illustrates a generalized frequency domain optical coherence tomography system used to collect 3D image data of the eye suitable, in accordance with various embodiments.

FIG. 6 shows an exemplary OCT B-scan image of a normal retina of a human eye, and illustratively identifies various canonical retinal layers and boundaries, in accordance with various embodiments.

FIG. 7 shows an example of an en face vasculature image, in accordance with various embodiments.

FIG. 8 shows an exemplary B-scan of a vasculature (OCTA) image, in accordance with various embodiments.

FIG. 9 illustrates an example of a computer system (or computing device or computer), in accordance with various embodiments.

### DETAILED DESCRIPTION

Optical coherence tomography (OCT) is a non-invasive imaging technique that uses light waves to penetrate tissue and produce image information at different depths within the tissue, such as an eye. Of particular interest is the use of an OCT system to image (e.g., scan) a target structure (e.g., the retina) of an eye. It is desirable to increase the point resolution, depth resolution, and depth penetration of each A-scan of an OCT system. It is also desirable to increase the scan speed of a B-scan. These objectives, however, result in increased data collection per OCT scan (e.g., B-scan or C-scan), which place higher data processing demands and data storage for the OCT system. For ease of discussion, the below examples illustrate the present method applied to one or more B-Scans, but it is to be understood that the present method may also be applied to C-scan data.

An OCT system and method identifies (or accepts user-defined) regions of interest (ROIs) within an OCT imaging scan (e.g., identifies relevant data for display and/or storage purposes), and discards OCT data outside the region of interest (e.g., target region). In this case, only the collected data within the defined region of interest is stored. An exemplary implementation applies the present OCT system to imaging the retina of an eye, as an exemplary target structure. As an OCT scan is made, it images the curvature of the retina. In the present example, only a target region of, for example, an original B-scan that corresponds to the retina is desired. Therefore, in the present example, it would be desirable for the target region to discard all OCT scan data above and below the retina (as defined along an axial direction). Optionally, the target region may be expanded to include a buffer region around (e.g., above and below) the retina. This buffer region may be of predefined (micrometer or pixel count or voxel count) size (equally sized or differently sized or of variable size) above and below the retina, or selected from a set of displayed size options, or freely entered by a user, or defined by a freely sizable selection box created by a user by means user input device such as a pointing device, keyboard, voice command, gaze detection input device, or other known user-to-computer interface. Irrespective of the buffer size, the method may be achieved by identifying the retina in the OCT data, and then extracting only target region (ROI) of the OCT image data that includes the retina, and optionally the buffer region above and below the retina. The extracted target region that includes the retina and optional buffer region may then be flattened. Alternatively, the original OCT data (e.g., B-scan or C-scan) of the retina may be flattened directly, and after flattening, a buffer region above and below the flattened retina may be defined for display to a viewer, or for storage.

Irrespective of how the target retina region is identified and extracted from the B-scan, the general shape of the curvature of the retina prior to flattening (e.g., curvature data) is determined and stored along with the flattened version of the retina. When wanting to display flattened OCT data (e.g., B-scan or C-scan), either from a newly acquired OCT scan (from an OCT system) or from a previous OCT scan accessed/recalled from (memory) storage, on a digital display (e.g., electronic/computer monitor/screen), a graphic illustrating (e.g., a linear representation of) the original curvature of the retina may be displayed (based on the stored curvature data) alongside (or superimposed on) the displayed flattened retina.

Optionally, the flattened retina data may be rearranged/reconfigured into its original, not-flattened formed and displayed on a screen by curving the previously flattened OCT data according to its correspondingly stored curvature data. In this manner, the original shape of the retina is recreated and displayed from the stored limited portion of the retina data. As mentioned above, it is beneficial to also display a graphical representation of the original curvature of the retinal. This graphic may be determined from the cropped region of the retinal prior to being flattened, as discussed below, or may be accessed from stored curvature data/information. By use of this graphic, a medical practitioner viewing the flattened retina may quickly ascertain the general shape of the retina and determine if its shape is normal or abnormal.

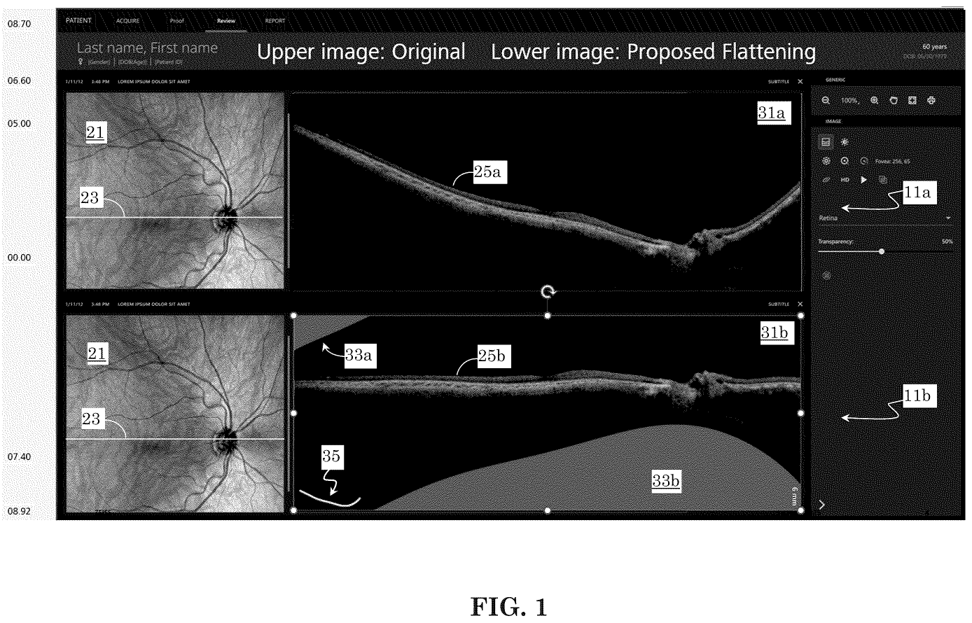

FIG. 1 illustrates the cropping and flattening of a B-scan of a retina, in accordance with various embodiments. FIG. 1 shows an original top (or upper) view 11a and a flattened bottom (or lower) view 11b. The top view 11a shows a fundus image 21 (defined from a C-scan) as a reference that may be used to show (such as by a bright line 23) where an original OCT B-scan 31a is extracted from. As shown, the retina 25a in original B-scan 31a is curved. The bottom view 11b shows an exemplary result of processing top view 11a, in accordance with various embodiments. In this example, tissue, e.g., retina 25a of original B-scan 31a, is flattened, as illustrated by representation 25b. Once the image 31b has been flattened in this way, one can clip off (e.g., remove or decimate) the top and bottom portions of image 31b (beyond upper and lower buffer regions as determined by a defined buffer range and the available upper and lower limits the viewable area of original B-scan view, whichever is smaller) where there is no tissue (e.g., no retina), thus saving (computer memory) storage space and also stretching the image to make image details more visible. Gray regions 33a/33b illustrate areas of original B-scan 31 a that are clipped (e.g., removed) form flattened B-scan 31b, such that only data corresponding to flattened tissue (e.g., retina) 25b remain (and optional buffer regions, shown as dark areas). However, a graphic 35 illustrates the original curvature of original retina 25a in original B-scan 31a.

It is noted that the shape of one or more gray regions may corresponds to the original retina shape, such that the shape of graphic 35 may be determined from the gray regions. For example, graphic 35 is shown to have shape substantially inverse to the upper outline of gray region 33b. In this manner, one displays the original shape of the retina, and saves/stores only a limited portion of the data based on the flattening (saving storage space). That is, only a select portion of image 31b is stored and recalled for display later.

Optionally, a doctor, technician, medical professional, or technician (e.g., the user or operator) may not be shown image portions outside a target region (e.g., gray regions 33b and 33a) in image 31b of bottom view 11b, by default. Instead, the bottom view 11b could show a reduced view window that avoids displaying gray regions 33a/33b, even if the flatten retina image 31b has not yet been cropped, such as if image 31b is newly acquired scan. A user may then zoom in and out of the newly acquired OCT scan to define the view window of flatten retina 31b that the user wishes to be stored. Any image data outside the selected view window would then be removed (discarded) prior to storing the OCT image data. Similarly, if a user is accessing a previously stored OCT image from storage, the retrieved OCT image data may be formatted to avoid displaying any gray regions (e.g., 33a and 33b), by default, although the user may still modify the display view window (e.g., zoom-out, zoom-in, enlarge, reduce, and/or move the view window), which could result in displaying the gray regions manually.

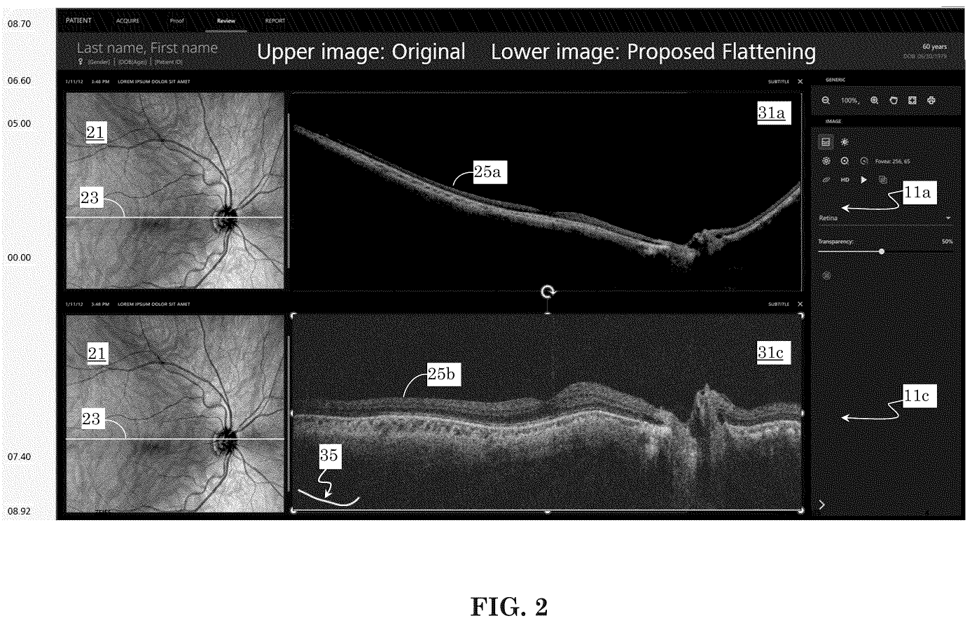

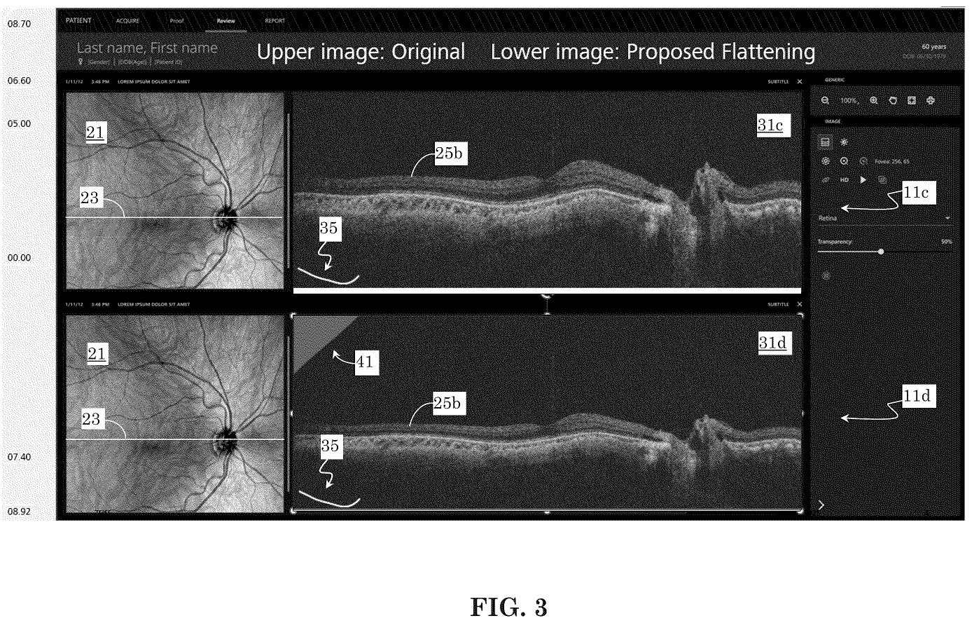

For example, lower view 11c of FIG. 2 shows a flatten retina image 31c (of original unflatten image 31a) an operator may see, by default. Note that the flatten retina image 31c defines a view window of a portion of flatten retina image 31b of FIG. 1, but the curvature of the displayed flatten retina within image 31c is illustrated/conveyed by graphic 35. For example, flatten image 31c is a zoomed-in (and optionally stretched) view of a portion of flatten retina image 31b such that gray regions 33a/33b of FIG. 1 are not shown (they are out of view) in image 31c. The operator would then have an option to manipulate the view window of image 31c by zooming out, or zooming in, or moving or resizing the view window, and/or by rotating the flattened B-scan 25b within the thus defined view window. FIG. 3 shows a zoomed-out view of flattened retina B-scan 31c of FIG. 2.

For illustration purposes, the top view 11c of FIG. 3 shows the bottom view 11c FIG. 2, and the bottom view 11d of FIG. 3 shows the zoomed-out view 31d of flattened retina B-scan 31c of FIG. 2. In FIG. 3, the image 31d is zoomed out such that regions that have no stored data are shown as gray regions 41.

Whichever view the user selects (either flattened or not) is saved along with information of the curvature of original B-scans shape 31a, as illustrated by graphic 35.

An exemplary process for displaying and storing OCT data (e.g., a B-scan) would include the following steps (or sequence), in accordance with various embodiments:
1) flatten the original retina OCT data and only display a reduced vertical range (e.g., buffer region) above and below the flattened retina to the operator/user (as illustrated by view 31c of FIG. 2). The bottom view 11b of FIG. 1 shows the flattening of the retina 25b, and FIG. 2 shows the portion of the flatten retina view 11c that would be displayed, avoiding any cropped regions 33a/33b of FIG. 1.
2) Allow the operator to change the range being displayed (in case desired tissue is clipped).
3) Only save the data range displayed (e.g., the ranged selected by the user).

Additionally, derive and show/display/store the original, not-flattened retinal shape (e.g., display graphic 35), which may be derived in the process of flattening the original retina image.

Thus, only the selected displayed range, as specified by the operator (or defined by default) is stored. Since this may be a fraction of the original B-scan view (e.g., top view 11a in FIG. 1), the full shape of the retina might not be discernable from the selected display range. Therefore, the original curvature of the retinal is also determined and stored. A graphic 35 of the full (or displayed part) of the retina shape/curvature is thereby obtained and displayed to the operator when a flatten retina view is viewed (e.g., recalled for viewing).

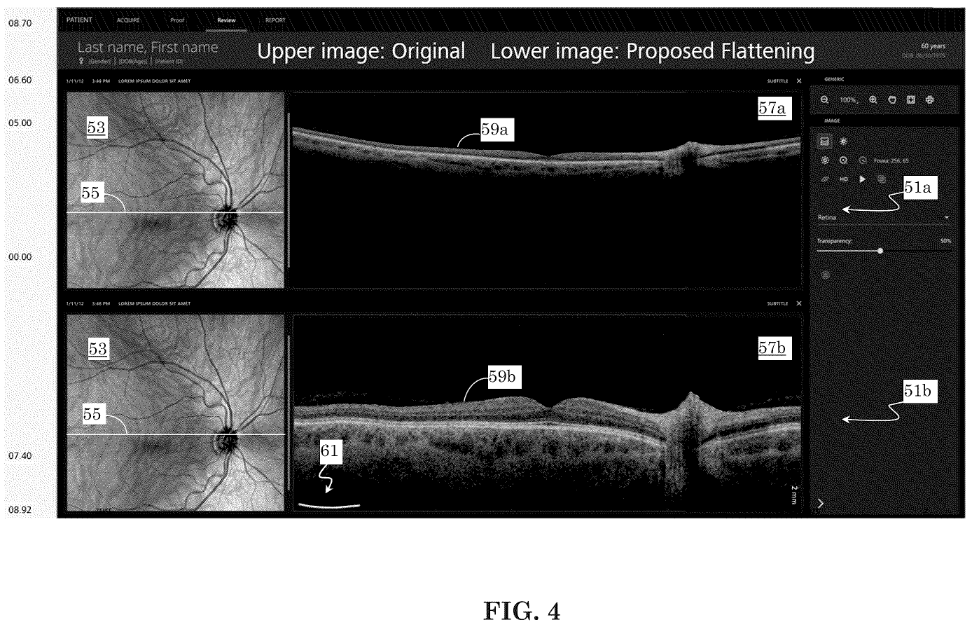

FIG. 4 shows another example of the method. Like in the previous example of FIGS. 1-3, for comparison, FIG. 4 shows an original OCT retina scan in a top view 51a, and a processed, flatten-retina view in a bottom view 51b. Both top view 51a and bottom view 51b show an enface image 53 and a line 55 delineating the direction and position of original B-scan 57 a and flattened B-scan 57b within the enface image 53. Original B-scan 57a shows the original curvature of retina 59a, which in the present example is shown having a shallow curve (e.g., a slow or gradual change across original B-scan 57a). The lower view 51b shows flattened, and zoomed-in retina 59b, as may be selected by an operator or defined by default. In this case, only the data shown in flattened retina B-scan 57b would be stored. Information defining the original curvature of retina 59a (or the portion of original retina 59a corresponding to the portion displayed in bottom view 51b) is stored. Bottom view 51b also shows graphic 61, which graphically illustrates retina curvature information (e.g., the original curvature of original retina 59a prior to it being flattened).

### Optical Coherence Tomography Imaging System

Generally, optical coherence tomography (OCT) uses low-coherence light to produce two-dimensional (2D) and three-dimensional (3D) internal views of biological tissue. OCT enables in vivo imaging of retinal structures. OCT angiography (OCTA) produces flow information, such as vascular flow from within the retina. Examples of OCT systems are provided in U.S. Pats. 6,741,359 and 9,706,915, and examples of an OCTA systems may be found in U.S. Pats. 9,700,206 and 9,759,544, all of which are herein incorporated in their entirety by reference. An exemplary OCT/OCTA system is provided herein.

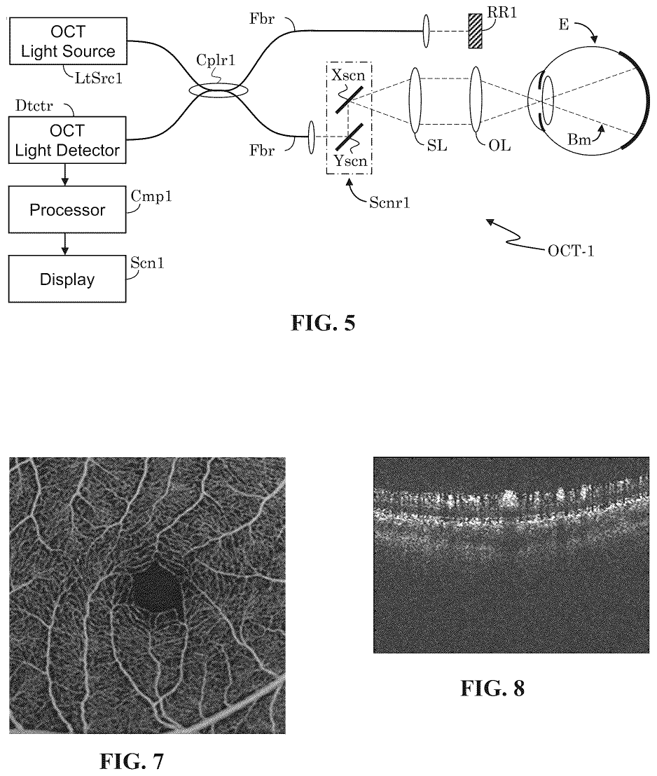

FIG. 5 illustrates a generalized frequency domain optical coherence tomography (FD-OCT) system used to collect 3D image data of the eye suitable for use, in accordance with various embodiments. An FD-OCT system OCT_1 includes a light source, LtSrc1. Typical light sources include, but are not limited to, broadband light sources with short temporal coherence lengths or swept laser sources. A beam of light from light source LtSrc1 is routed, typically by optical fiber Fbr1, to illuminate a sample, e.g., eye E; a typical sample being tissues in the human eye. The light source LrSrc1 may, for example, be a broadband light source with short temporal coherence length in the case of spectral domain OCT (SD-OCT) or a wavelength tunable laser source in the case of swept source OCT (SS-OCT). The light may be scanned, typically with a scanner Scnr1 between the output of the optical fiber Fbr1 and the sample E, so that the beam of light (dashed line Bm) is scanned laterally over the region of the sample to be imaged. The light beam from scanner Scnr1 may pass through a scan lens SL and an ophthalmic lens OL and be focused onto the sample E being imaged. The scan lens SL (or telecentric scan lens) is used to scan a light beam across the sample. The scan lens helps ensure the light beam's focal point (or focal line) moves linearly and consistently across a flat imaging plane. Together with the ophthalmic lens OL, the light beam is focused onto the sample. The present example illustrates a scan beam that is scanned in two lateral directions (e.g., in x and y directions on a Cartesian plane) to scan a desired field of view (FOV). An example of this would be a point-field OCT, which uses a point-field beam to scan across a sample. Consequently, scanner Scnr1 is illustratively shown to include two sub-scanner: a first sub-scanner Xscn for scanning the point-field beam across the sample in a first direction (e.g., a horizontal x-direction); and a second sub-scanner Yscn for scanning the point-field beam on the sample in traversing second direction (e.g., a vertical y-direction). If the scan beam were a line-field beam (e.g., a line-field OCT), which may sample an entire line-portion of the sample at a time, then only one scanner may be used to scan the line-field beam across the sample to span the desired FOV. If the scan beam were a full-field beam (e.g., a full-field OCT), no scanner may be used, and the full-field light beam may be applied across the entire, desired FOV at once.

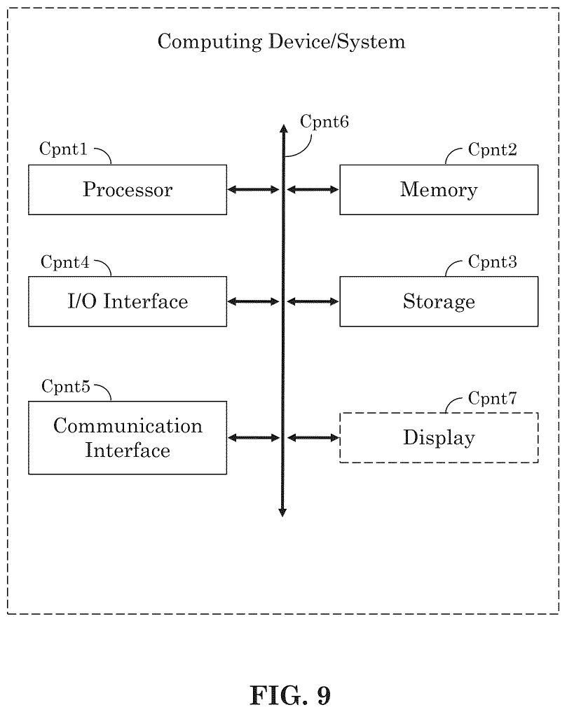

Irrespective of the type of beam used, light scattered from the sample (e.g., sample light) is collected. In the present example, scattered light returning from the sample is collected into the same optical fiber Fbr1 used to route the light for illumination. Reference light derived from the same light source LtSrc1 travels a separate path, in this case involving optical fiber Fbr2 and retro-reflector RR1 with an adjustable optical delay. Those skilled in the art will recognize that a transmissive reference path can also be used and that the adjustable delay could be placed in the sample or reference arm of the interferometer. Collected sample light is combined with reference light, for example, in a fiber coupler Cplr1, to form light interference in an OCT light detector Dtctr1 (e.g., photodetector array, digital camera, etc.). Although a single fiber port is shown going to the detector Dtctr1, those skilled in the art will recognize that various designs of interferometers can be used for balanced or unbalanced detection of the interference signal. The output from the detector Dtctr1is supplied to a processor (e.g., internal or external computing device) Cmp1 that converts the observed interference into depth information of the sample. The depth information may be stored in a memory associated with the processor Cmp1 and/or displayed on a display (e.g., computer/electronic display/screen) Scn1. The processing and storing functions may be localized within the OCT instrument, or functions may be offloaded onto (e.g., performed on) an external processor (e.g., an external computing device), to which the collected data may be transferred. An example of a computing device (or computer system) is shown in FIG. 9. This unit could be dedicated to data processing or perform other tasks which are quite general and not dedicated to the OCT device. The processor (computing device) Cmp1 may include, for example, a field-programmable gate array (FPGA), a digital signal processor (DSP), an application specific integrated circuit (ASIC), a graphics processing unit (GPU), a system on chip (SoC), a central processing unit (CPU), a general purpose graphics processing unit (GPGPU), or a combination thereof, that may performs some, or the entire, processing steps in a serial and/or parallelized fashion with one or more host processors and/or one or more external computing devices.

The sample and reference arms in the interferometer could consist of bulk-optics, fiber-optics, or hybrid bulk-optic systems and could have different architectures such as Michelson, Mach-Zehnder or common-path based designs as would be known by those skilled in the art. Light beam as used herein should be interpreted as any carefully directed light path. Instead of mechanically scanning the beam, a field of light can illuminate a one or two-dimensional area of the retina to generate the OCT data (see for example, U.S. Pat. No. 9,332,902; D. Hillmann et al, “Holoscopy—Holographic Optical Coherence Tomography,” Optics Letters, 36(13): 2390 2011; Y. Nakamura, et al, “High-Speed Three Dimensional Human Retinal Imaging by Line Field Spectral Domain Optical Coherence Tomography,” Optics Express, 15(12): 7103 2007; Blazkiewicz et al, “Signal-To-Noise Ratio Study of Full-Field Fourier-Domain Optical Coherence Tomography,” Applied Optics, 44(36): 7722 (2005)). In time-domain systems, the reference arm has a tunable optical delay to generate interference. Balanced detection systems are typically used in TD-OCT and SS-OCT systems, while spectrometers are used at the detection port for SD-OCT systems. The method described herein could be applied to any type of OCT system. Various aspects of the method could apply to any type of OCT system or other types of ophthalmic diagnostic systems and/or multiple ophthalmic diagnostic systems including but not limited to fundus imaging systems, visual field test devices, and scanning laser polarimeters.

In Fourier Domain optical coherence tomography (FD-OCT), each measurement is the real-valued spectral interferogram (Sj(k)). The real-valued spectral data typically goes through several post-processing steps including background subtraction, dispersion correction, etc. The Fourier transform of the processed interferogram, results in a complex valued OCT signal output Aj(z)=|Aj|eiφ. The absolute value of this complex OCT signal, |Aj|, reveals the profile of scattering intensities at different path lengths, and therefore scattering as a function of depth (z-direction) in the sample. Similarly, the phase, φj can also be extracted from the complex valued OCT signal. The profile of scattering as a function of depth is called an axial scan (A-scan). A set of A-scans measured at neighboring locations in the sample produces a cross-sectional image (tomogram or B-scan) of the sample. A collection of B-scans collected at different transverse locations on the sample makes up a data volume or cube. For a particular volume of data, the term fast axis refers to the scan direction along a single B-scan whereas slow axis refers to the axis along which multiple B-scans are collected. The term “cluster scan” may refer to a single unit or block of data generated by repeated acquisitions at the same (or substantially the same) location (or region) for the purposes of analyzing motion contrast, which may be used to identify blood flow. A cluster scan can consist of multiple A-scans or B-scans collected with relatively short time separations at approximately the same location(s) on the sample. Since the scans in a cluster scan are of the same region, static structures remain relatively unchanged from scan to scan within the cluster scan, whereas motion contrast between the scans that meets predefined criteria may be identified as blood flow.

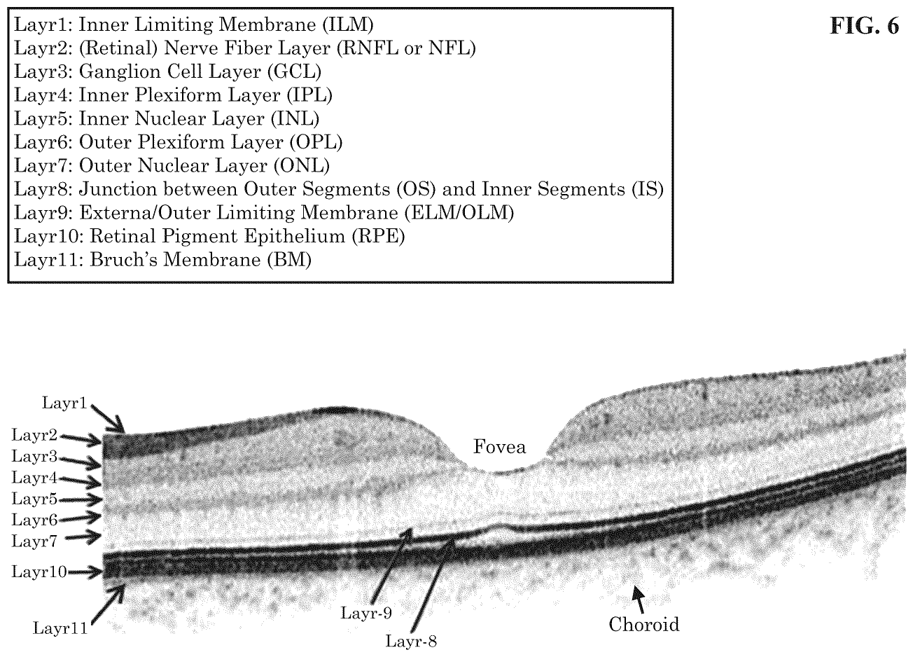

A variety of ways to create B-scans are known in the art including but not limited to: along the horizontal or x-direction, along the vertical or y-direction, along the diagonal of x and y, or in a circular or spiral pattern. B-scans may be in the x-z dimensions but may be any cross-sectional image that includes the z-dimension. An example OCT B-scan image of a normal retina of a human eye is illustrated in FIG. 6. An OCT B-scan of the retinal provides a view of the structure of retinal tissue. For illustration purposes, FIG. 6 identifies various canonical retinal layers and layer boundaries. The identified retinal boundary layers include (from top to bottom): the inner limiting membrane (ILM) Lyer1, the retinal nerve fiber layer (RNFL or NFL) Layr2, the ganglion cell layer (GCL) Layr3, the inner plexiform layer (IPL) Layr4, the inner nuclear layer (INL) Layr5, the outer plexiform layer (OPL) Layr6, the outer nuclear layer (ONL) Layr7, the junction between the outer segments (OS) and inner segments (IS) (indicated by reference character Layr8) of the photoreceptors, the external or outer limiting membrane (ELM or OLM) Layr9, the retinal pigment epithelium (RPE) Layr10, and the Bruch's membrane (BM) Layr11.

In OCT Angiography, or Functional OCT, analysis algorithms may be applied to OCT data collected at the same, or approximately the same, sample locations on a sample at different times (e.g., a cluster scan) to analyze motion or flow (see for example US Patent Publication Nos. 2005/0171438, 2012/0307014, 2010/0027857, 2012/0277579 and U.S. Pat. No. 6,549,801, all of which are herein incorporated in their entirety by reference). An OCT system may use any one of a number of OCT angiography processing algorithms (e.g., motion contrast algorithms) to identify blood flow. For example, motion contrast algorithms can be applied to the intensity information derived from the image data (intensity-based algorithm), the phase information from the image data (phase-based algorithm), or the complex image data (complex-based algorithm). An en face image is a 2D projection of 3D OCT data (e.g., by averaging the intensity of each individual A-scan, such that each A-scan defines a pixel in the 2D projection). Similarly, an en face vasculature image is an image displaying motion contrast signal in which the data dimension corresponding to depth (e.g., z-direction along an A-scan) is displayed as a single representative value (e.g., a pixel in a 2D projection image), typically by summing or integrating all or an isolated portion of the data (see for example U.S. Pat. No. 7,301,644 herein incorporated in its entirety by reference). OCT systems that provide an angiography imaging functionality may be termed OCT angiography (OCTA) systems.

FIG. 7 shows an example of an en face vasculature image. After processing the data to highlight motion contrast using any of the motion contrast techniques known in the art, a range of pixels corresponding to a given tissue depth from the surface of internal limiting membrane (ILM) in retina, may be summed to generate the en face (e.g., frontal view) image of the vasculature. FIG. 8 shows an exemplary B-scan of a vasculature (OCTA) image. As illustrated, structural information may not be well-defined since blood flow may traverse multiple retinal layers making them less defined than in a structural OCT B-scan, as shown in FIG. 6. Nonetheless, OCTA provides a non-invasive technique for imaging the microvasculature of the retina and the choroid, which may be critical to diagnosing and/or monitoring various pathologies. For example, OCTA may be used to identify diabetic retinopathy by identifying microaneurysms, neovascular complexes, and quantifying foveal avascular zone and nonperfused areas. Moreover, OCTA has been shown to be in good agreement with fluorescein angiography (FA), a more traditional, but more evasive, technique using the injection of a dye to observe vascular flow in the retina. Additionally, in dry age-related macular degeneration, OCTA has been used to monitor a general decrease in choriocapillaris flow. Similarly in wet age-related macular degeneration, OCTA can provides a qualitative and quantitative analysis of choroidal neovascular membranes. OCTA has also been used to study vascular occlusions, e.g., evaluation of nonperfused areas and the integrity of superficial and deep plexus.

### Computing Device/System

FIG. 9 illustrates an example computer system (or computing device or computer device). In some embodiments, one or more computer systems may provide the functionality described or illustrated herein and/or perform one or more steps of one or more methods described or illustrated herein. The computer system may take any suitable physical form. For example, the computer system may be an embedded computer system, a system-on-chip (SOC), a single-board computer system (SBC) (such as, for example, a computer-on-module (COM) or system-on-module (SOM)), a desktop computer system, a laptop or notebook computer system, a mesh of computer systems, a mobile telephone, a personal digital assistant (PDA), a server, a tablet computer system, an augmented/virtual reality device, or a combination of two or more of these. Where appropriate, the computer system may reside in a cloud, which may include one or more cloud components in one or more networks.

In some embodiments, the computer system may include a processor Cpnt1, memory Cpnt2, (memory) storage Cpnt3, an input/output (I/O) interface Cpnt4, a communication interface Cpnt5, and a bus Cpnt6. The computer system may optionally also include a display Cpnt7, such as a computer monitor or screen.

Processor Cpnt1 includes hardware for executing instructions, such as those making up a computer program. For example, processor Cpnt1 may be a central processing unit (CPU) or a general-purpose computing on graphics processing unit (GPGPU). Processor Cpnt1 may retrieve (or fetch) the instructions from an internal register, an internal cache, memory Cpnt2, or storage Cpnt3, decode and execute the instructions, and write one or more results to an internal register, an internal cache, memory Cpnt2, or storage Cpnt3. In particular embodiments, processor Cpnt1 may include one or more internal caches for data, instructions, or addresses. Processor Cpnt1 may include one or more instruction caches, one or more data caches, such as to hold data tables. Instructions in the instruction caches may be copies of instructions in memory Cpnt2 or storage Cpnt3, and the instruction caches may speed up retrieval of those instructions by processor Cpnt1. Processor Cpnt1 may include any suitable number of internal registers, and may include one or more arithmetic logic units (ALUs). Processor Cpnt1 may be a multi-core processor; or include one or more processors Cpnt1. Although this disclosure describes and illustrates a particular processor, this disclosure contemplates any suitable processor.

Memory Cpnt2 may include main memory for storing instructions for processor Cpnt1 to execute or to hold interim data during processing. For example, the computer system may load instructions or data (e.g., data tables) from storage Cpnt3 or from another source (such as another computer system) to memory Cpnt2. Processor Cpnt1 may load the instructions and data from memory Cpnt2 to one or more internal register or internal cache. To execute the instructions, processor Cpnt1 may retrieve and decode the instructions from the internal register or internal cache. During or after execution of the instructions, processor Cpnt1 may write one or more results (which may be intermediate or final results) to the internal register, internal cache, memory Cpnt2 or storage Cpnt3. Bus Cpnt6 may include one or more memory buses (which may each include an address bus and a data bus) and may couple processor Cpnt1 to memory Cpnt2 and/or storage Cpnt3. Optionally, one or more memory management unit (MMU) facilitate data transfers between processor Cpnt1 and memory Cpnt2. Memory Cpnt2 (which may be fast, volatile memory) may include random access memory (RAM), such as dynamic RAM (DRAM) or static RAM (SRAM). Storage Cpnt3 may include long-term or mass storage for data or instructions. Storage Cpnt3 may be internal or external to the computer system, and include one or more of a disk drive (e.g., hard-disk drive, HDD, or solid-state drive, SSD), flash memory, ROM, EPROM, optical disc, magneto-optical disc, magnetic tape, Universal Serial Bus (USB)-accessible drive, or other type of non-volatile memory.

I/O interface Cpnt4 may be software, hardware, or a combination of both, and include one or more interfaces (e.g., serial or parallel communication ports) for communication with I/O devices, which may enable communication with a person (e.g., user). For example, I/O devices may include a keyboard, keypad, microphone, monitor, mouse, printer, scanner, speaker, still camera, stylus, tablet, touch screen, trackball, video camera, another suitable I/O device, or a combination of two or more of these.

Communication interface Cpnt5 may provide network interfaces for communication with other systems or networks. Communication interface Cpnt5 may include a Bluetooth interface or other type of packet-based communication. For example, communication interface Cpnt5 may include a network interface controller (NIC) and/or a wireless NIC or a wireless adapter for communicating with a wireless network. Communication interface Cpnt5 may provide communication with a WI-FI network, an ad hoc network, a personal area network (PAN), a wireless PAN (e.g., a Bluetooth WPAN), a local area network (LAN), a wide area network (WAN), a metropolitan area network (MAN), a cellular telephone network (such as, for example, a Global System for Mobile Communications (GSM) network), the Internet, or a combination of two or more of these.

Bus Cpnt6 may provide a communication link between the above-mentioned components of the computing system. For example, bus Cpnt6 may include an Accelerated Graphics Port (AGP) or other graphics bus, an Enhanced Industry Standard Architecture (EISA) bus, a front-side bus (FSB), a HyperTransport (HT) interconnect, an Industry Standard Architecture (ISA) bus, an InfiniBand bus, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or other suitable bus or a combination of two or more of these.

Although this disclosure describes and illustrates a particular computer system having a particular number of particular components in a particular arrangement, this disclosure contemplates any suitable computer system having any suitable number of any suitable components in any suitable arrangement.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

While the method has been described in conjunction with several specific embodiments, it is evident to those skilled in the art that many further alternatives, modifications, and variations will be apparent in light of the foregoing description. Thus, the method described herein is intended to embrace all such alternatives, modifications, applications and variations as may fall within the spirit and scope of the appended claims.

1. A method of processing optical coherence tomography (OCT) data, comprising:
acquiring an OCT scan of the retina of an eye;
substantially flattening the retina information within the OCT scan;
displaying, on an electronic display, a first portion of the flattened retina information avoiding regions of non-OCT data in the flattened retina information;
accepting input, by a user input device, to modify the displayed first portion of the flattened retina and define a second portion of the flattened retina information;
removing from the flattened retina information any OCT data not within the second portion of the flattened retina information to define a cropped OCT data scan; and
storing in a computer-accessible memory the cropped OCT data scan.

2. The method of claim 1, wherein the first portion of the flattened retina information includes at least a select portion of the flattened retina information and a buffer region above and below the select portion of the flattened retina within the OCT data.

3. The method of claim 2, wherein the buffer region is modified by means of the user input device.

4. The method of claim 1, further including:
displaying, on the electronic display, a graphic conveying the curvature of the scanned retina prior to the flattening of the retina information within the OCT scan.

5. The method of claim 4, wherein the graphic is displayed alongside or superimposed on the displayed first portion of the flattened retina information.

6. The method of claim 4, wherein the flattening the retina information within the OCT scan defines a region of no OCT data below the flattened retina information, and the curvature of the retina prior to the flattening is defined as the inverse of the shape of the lower side of the defined region of no OCT data below the flattened retina information.

7. The method of claim 4, wherein the graphic conveys the curvature of a span of the retina larger than the span of cropped OCT data scan.

8. A method of displaying stored OCT scan data of the retina of an eye, comprising:
accessing the stored OCT scan data from a memory store, the stored OCT scan data being a flattened representation of the retina and including curvature information of the retina prior to creation of the flattened representation of the retina; and
displaying on an electronic display, the flattened representation of the retina and a graphic conveying the curvature information of the retina.

9. The method of claim 8, wherein:
the stored OCT scan data is a cropped portion of a full OCT scan of the retina;
a span length of the stored flattened representation of the retina is shorter than the span length of the full OCT scan of the retina; and
the stored curvature information includes curvature information of the stored cropped portion of the full OCT scan of the retina and curvature information beyond the stored cropped portion of the full OCT scan of the retina.

10. The method of claim 8, wherein:
the stored OCT scan data is a cropped portion of a full OCT scan of the retina;
a span length of the stored flattened representation of the retina is shorter than the span length of the full OCT scan of the retina;
the stored curvature information is of the full curvature of the full OCT scan of the retina.
